(19) United States
(12) Patent Application Publication
(10) Pub. No.: US 2012/0140096 A1
(43) Pub. Date: Jun. 7, 2012

(54) Timing Solution for Projector Camera Devices and Systems

(75) Inventors: Petter Östlund, Lund (SE); Martin Ek, Dalby (SE)

(73) Assignee: Sony Ericsson Mobile Communications AB, Lund (SE)

(21) Appl. No.: 12/957,742

(22) Filed: Dec. 1, 2010

(51) Int. Cl. H04N 5/217

(52) U.S. Cl. 348/241; 348/333.1; 348/E05.078

(57) ABSTRACT

An imaging system includes an integrated projector that projects images on to an external display surface and a digital camera that records gestures and/or other objects that are in or illuminated by the projected images. The camera and/or the projector generate a timing signal to synchronize a refresh rate of the projector with an exposure time of the digital camera. The synchronization reduces or eliminates interference patterns that may be caused by gestures in or illuminated by the projected image, and allows the digital camera to more accurately detect the gestures.

### FIELD OF THE INVENTION

The present invention relates generally to digital cameras equipped to record a projected image, and particularly to methods of detecting gestures illuminated by the projected image.

### BACKGROUND

Digital cameras are well-known devices that allow users to capture images, and in some cases, video. In addition to these conventional functions, an emerging technology also allows digital camera to also function as a projector. Particularly, a device called a “pico-projector” is a very small projection system integrated within the housings of the digital camera. When equipped with a pico-projector, a digital camera can project “scaled-up” versions of the images and video it captures onto a flat external surface, such as the side of a wall or a movie screen, for display to other people.

Often times, people will stand in front or to the side of a projected image and point or make other gestures with a hand, tool, or other indicator to note important text, pictures, or other items that are visible in the projected image. Additionally, some people may want to record the projected image to detect these gestures. However, the projected image will illuminate the object that is used to make the gesture (i.e., the hand or a tool). If the pico-projector is not synchronized to the digital camera, certain well-known interference patterns can occur. One such pattern is known as a Moiré pattern and can interfere with the detecting the gestures.

### SUMMARY

The present invention provides a digital camera that records a gesture that is in or is illuminated by a projected image. The gesture may be made, for example, by a part of a person's body, such as a person's hand, or by a tool or other indicator. More particularly, the present invention synchronizes a timing of a projector projecting the image with that of a digital camera recording the gestures in or illuminated by the projected image. Once recorded, the digital camera analyzes the content of the recorded image to accurately detect the presence of the gesture. The synchronization of the projector to the digital camera reduces or eliminates Moiré patterns from the recorded image so that the analysis can more accurately detect the gesture.

Accordingly, the present invention provides a method of detecting gestures that are in or are illuminated be a recorded image. In one embodiment, the method comprises projecting an image onto an external display surface using a projector, recording a gesture in or illuminated by the projected image using a digital camera, synchronizing a refresh rate of the projector with an exposure time of the digital camera, and detecting the gesture in or illuminated by the recorded image.

In one embodiment, analyzing the content of the recorded image to determine whether an interference pattern is visible in the recorded image.

In one embodiment, the interference pattern comprises a Moiré pattern.

In one embodiment, synchronizing a refresh rate of the projector with an exposure time of the digital camera comprises generating a control signal to filter the interference pattern from the image being recorded.

In one embodiment, generating the control signal comprises generating the control signal to synchronize the exposure time of a lens on the digital camera to the refresh rate of the projector.

In one embodiment, generating the control signal comprises generating a timing signal to synchronize the refresh rate of the projector to the exposure time of a lens on the digital camera.

In one embodiment, the method further comprises tuning the synchronization of the projector to the digital camera while projecting the image onto the external display surface.

In one embodiment, the method further comprises generating an adjusted control signal based on the generated control signal, adjusting the synchronization of the refresh rate of the projector with the exposure time of the digital camera based on the adjusted control signal, and projecting the image onto the external display surface according to the synchronized refresh rate.

In one embodiment, the method further comprises image processing the recorded image to determine the gesture.

In one embodiment, the gesture is determined to be a hand gesture.

In one embodiment, synchronizing a refresh rate of the projector with an exposure time of the digital camera comprises synchronizing the refresh rate of the projector to a start of the exposure of the digital camera.

In one embodiment, the present invention also contemplates an imaging system for detecting gestures in a recorded image. In one embodiment, the image-projection device comprises a projector configured to project an image onto an external display surface, a digital camera to record a gesture in or illuminated by the projected image, a controller connected to both the projector and the digital camera and configured to synchronize a refresh rate of the projector with an exposure time of the digital camera based on a generated control signal, and an image processor configured to detect the gesture.

In one embodiment, the image processor is further configured to analyze the content of the recorded image to determine whether an interference pattern is present in the recorded image.

In one embodiment, the image processor is further configured to generate the control signal if the image processor detects the interference pattern.

In one embodiment, the controller is further configured to generate a timing signal responsive to receiving the control signal from the image processor.

In one embodiment, the projector is configured to generate a timing signal responsive to receiving the control signal.

In one embodiment, the controller is further configured to generate an adjusted timing signal to tune the synchronization of the refresh rate of the projector with a start of the exposure of the digital camera.

In one embodiment, the projector comprises a pico-projector and is integrated with the digital camera as a single device.

Of course, those skilled in the art will appreciate that the present invention is not limited to the above contexts or examples, and will recognize additional features and advantages upon reading the following detailed description and upon viewing the accompanying drawings.

### BRIEF DESCRIPTION OF THE DRAWINGS

FIG. 1 is a perspective view illustrating an imaging system that projects images and/or video onto an external display surface, and then records hand gestures illuminated by the projected images according to one embodiment of the present invention.

FIG. 2 is a perspective view illustrating a Moiré pattern of the type that is reduced or eliminated when using a method of one embodiment of the present invention.

FIG. 3 is a block diagram illustrating some of the component parts of an imaging system configured to operate according to one embodiment of the present invention.

FIG. 4 is a flow diagram illustrating how an imaging system synchronizes the projector with the digital camera to reduce or eliminate interference patterns according to one embodiment of the present invention.

FIG. 5 is a flow diagram illustrating how an imaging system tunes the synchronization according to one or more embodiments of the present invention.

FIG. 6 is a perspective view illustrating an imaging system configured to operate according to another of the present invention.

FIG. 7 is a perspective view illustrating an imaging system that projects images and/or video onto an external display surface, and then records hand gestures occurring in the projected images according to one embodiment of the present invention.

### DETAILED DESCRIPTION

The present invention provides a method that more accurately detects gestures that are in or illuminated by projected images by synchronizing the timing between a projecting device and a recording device. The gestures may be any gesture known in the art and be made by any object. However, in one embodiment, the gestures are made by a part of a person's body. For example, in one embodiment, the gestures are hand gestures that point or draw attention to certain objects or items in the projected image, and be made by people standing proximate the projected image. In another embodiment, the gesture is made by a tool or other indicator that is in or illuminated by the projected image, and is controlled and/or operated by a user. It should be noted that the following description and the figures illustrate the gesture as being a hand gesture; however, this is for illustrative purposes only. Those skilled in the art will appreciate that, as stated above, the gestures need not be only hand gestures, but rather can be gestures made using a tool or other indicator as needed or desired.

Particularly, the present invention comprises an imaging system that incorporates an image projection device and an image recording device. The projecting device may be, for example, a pico-projector that projects an image onto an external display surface such as a wall or movie screen. The image recording device may comprise a digital camera, for example, that records the projected image and the gesture in or illuminated by the projected image. Often times, a moving hand, tool, or object can create undesirable interference patterns, such as Moire patterns, to be visible in the recorded content. Such patterns can interfere with the analysis of the recorded content, and therefore, interfere with the ability to accurately detect the gestures made by a person standing proximate the projected image. Therefore, while the digital camera records the projected image, the present invention synchronizes a timing of the projector with a start of the exposure of the digital camera. This reduces or eliminates the interference patterns associated with recording the gestures, and allows digital image processors to more accurately analyze and detect the gestures in the recorded content.

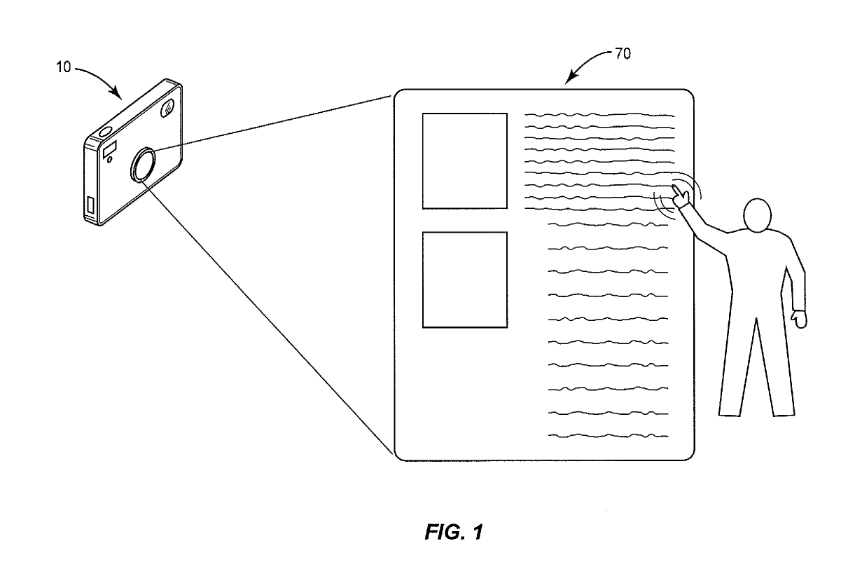

Turning now to the drawings, FIG. 1 illustrates a perspective view of a hand-held, portable, imaging system 10 configured to include a pico-projector and a digital camera according to one embodiment of the present invention. As seen in FIG. 1, a user can employ the pico-projector of imaging system 10 to project a video image 70 on a flat display surface such as a wall or screen, for example. The video image 70 being projected may be stored in and provided by the digital camera, or, as is seen in more detail later, by another device that is independent of the imaging system 10.

In FIG. 1, a person is standing proximate the projected video image 70 and making hand gestures to point to objects or items of interest in the video image 70. The user's hand gestures are illuminated by the projected video image 70. The digital camera of imaging system 10 records these illuminated hand gestures along with the video image 70, and then analyzes the content to detect the hand gestures. However, while recording the illuminated hand gestures, interference patterns may obscure the hand gestures. The present invention detects these patterns and synchronizes the timing between the projector and the digital camera to “filter” the interference patterns out of the recorded image content. The “filtered” image is then passed to an image processing function where the presence of the hand gestures is more easily detected.

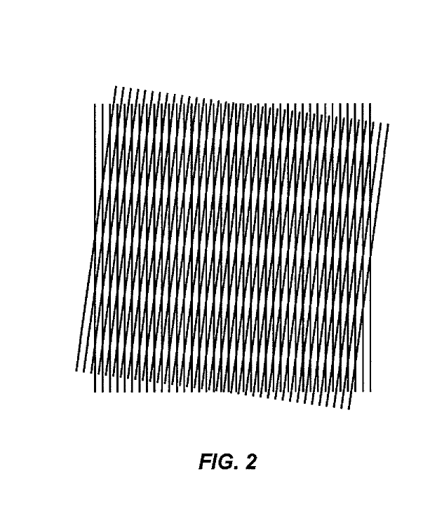

One type of interference pattern that can be avoided by the present invention is seen in FIG. 2 and is known as a “Moiré” pattern. Moiré patterns tend to interfere with the imaging system's 10 ability to analyze the recorded images. As such, it can be difficult for imaging system 10 to accurately detect a hand gesture that is in or is illuminated by the projected image. Moiré patterns can be produced by various digital imaging and computer graphics techniques, and may also be generated when the timing of the projector and the digital camera are not synchronized. Generally, Moiré patterns consist of a plurality of dark stripes that obscure the user's illuminated hand. The stripes, which may be vertical, and/or horizontal, and/or arcuate interfere with the ability to analyze the images to detect the hand gestures.

Manufacturers of devices that are able to record projected images, such as the imaging system 10, for example, typically desire projectors (i.e., pico-projectors) that are as compact as possible to facilitate the integration of a projection device and an image capturing device into a single unit. Some devices, such as conventional scanning devices, are already faced with the problem of removing Moiré patterns from images. However, those devices are not required to detect hand gestures that are in or are illuminated by video images. Further, they typically utilize hardware components such as de-screening filters to remove Moiré patterns from their images. Such filters are “extra” components that increase both the size and the draw on the limited power resources available to the device. Therefore, instead of using conventional filter components to remove interference patterns, the present invention utilizes a signal to synchronize the timing between the projector and the digital camera.

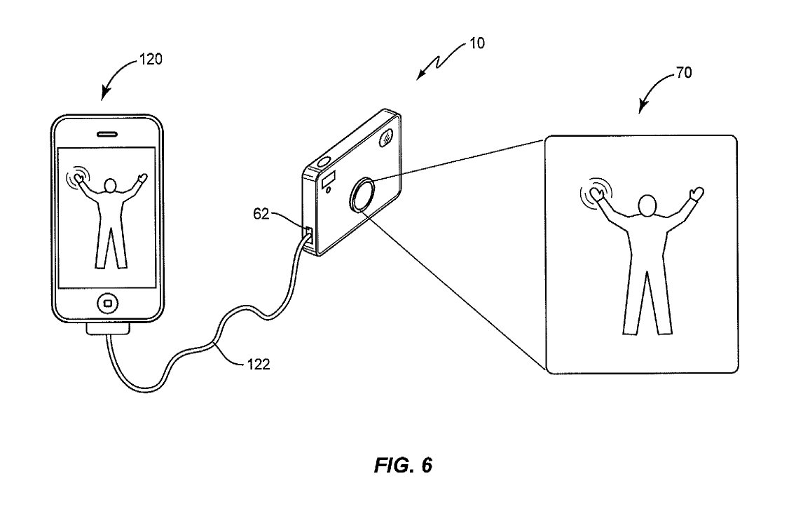

The control signal is generated to synchronize the refresh rate of the projector to the exposure time of the digital camera. The control signal is generated using any known method and/or component. However, in one embodiment, the control signal may be generated by a hardware component integrated into the digital camera part of the imaging system 10, such as an image processor, for example. Alternatively, it may be a signal generated by a controller in the imaging system 10 that is connected to both the pico-projector and the digital camera. In these first two scenarios, the pico-projector simply receives the generated control signal and performs a process to synchronize its refresh rate with the exposure time of the digital camera. However, in another embodiment, the pico-projector includes circuitry that generates the control signal used in the synchronization process. In yet another embodiment, seen later in FIG. 6, the control signal is generated and sent to the imaging system 10 by an external device. The signal may be received by the imaging system 10 via a Mobile Industry Processor Interface (MIPI) Interface, for example.

Regardless of how or where the control signal is generated, the pico-projector is configured to utilize the control signal to synchronize its refresh rate with the exposure time of the digital camera. Once synchronized, the digital camera can record the images being projected by the pico-projector without recording the annoying patterns that degenerate the ability of the digital-camera to detect hand gestures illuminated by the projected video image 70.

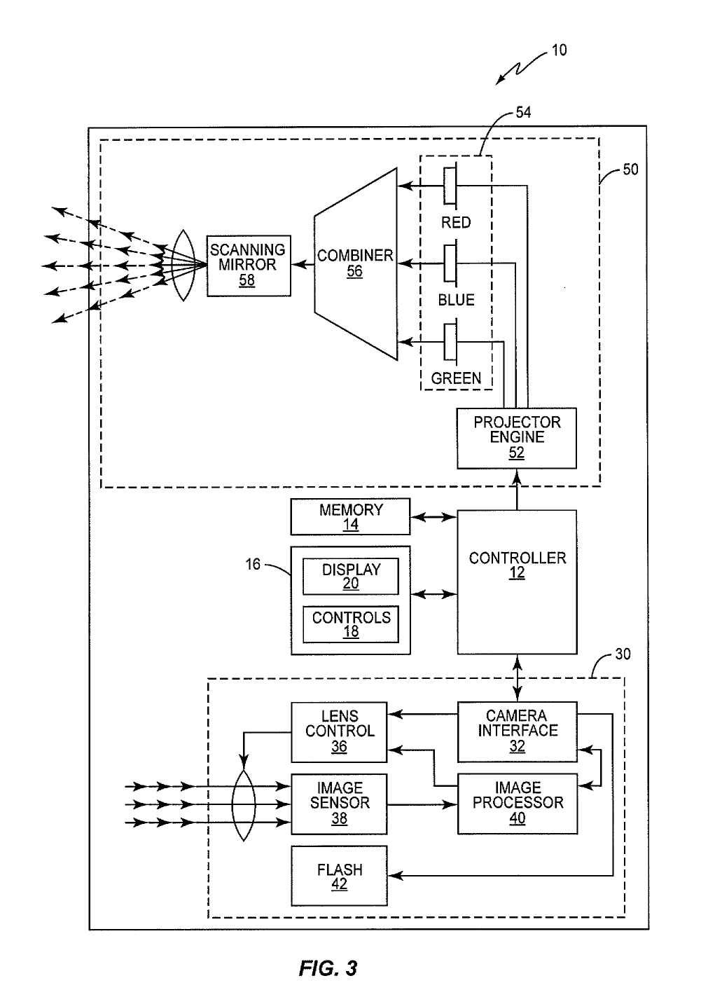

FIG. 3 is a block diagram illustrating some of the component parts of imaging system 10 configured to reduce or eliminate Moiré patterns according to one embodiment of the present invention. As seen in FIG. 3, the imaging system 10 comprises a controller 12, a memory 14, a User Interface (UI) 16 having user controls 18, and a display 20, as well as the digital camera 30 and a pico-projector 50. In this embodiment, the controller 12, memory 14, and the UI 16 are central to both the digital camera 30 and the pico-projector 50. Thus, each of these components serves both the digital camera 30 and the pico-projector 50. However, this is not required, and each of the digital camera 30 and pico-projector 50 may include their own such components.

The controller 12 controls the operation of imaging system 10 according to one or more programs and data stored in memory 14. In this embodiment, this includes controlling the functions of the digital camera 30 as well as those of the pica-projector 50. The controller 12 may be implemented as a single microprocessor or multiple microprocessors. Suitable microprocessors may include, for example, general purpose and special purpose microprocessors as well as digital signal processors and/or image processors. In one embodiment of the present invention, the memory 14 stores an executable program that is executed by controller 12. When executed, the program causes the controller 12 to control the pico-projector 50 to project the video image 70 onto the external display surface.

Additionally, controller 12 may be configured to control the synchronization of the refresh rate of the pico-projector 50 with the exposure time of the imaging system 10. For example, in one embodiment, controller 12 generates a control signal to send to the pico-projector 50. The control signal may comprise, for example, a timing signal that pico-projector 50 uses to synchronize its refresh rate to a start of the exposure of the digital camera 10. In another embodiment, the controller 12 generates and sends the control signal to a camera interface 32 in digital camera 30. The signal controls a lens control component 36 to increase or decrease its exposure time so as to synchronize it with the refresh rate of the pica-projector 50. Thus, synchronization may occur in the pico-projector 50 or in the digital camera 30.

Memory 14 is a computer readable medium representing the entire hierarchy of memory in imaging system 10, and may comprise both random access memory (RAM) and read-only memory (ROM). Computer program instructions and data required for operation of the digital camera 30 and/or the pico-projector 50 are stored in non-volatile memory, such as EPROM, EEPROM, and/or flash memory, while images and/or video captured by the digital camera 30 may be stored in volatile memory. Memory 14 and may be implemented, for example, as one or more discrete devices, stacked devices, or removable devices, such as a flash drive or memory stick, or may be integrated with controller 12.

The User interface (UI) 16 generally includes one or more components that permit the user to interact with, and control the operation of, the imaging system 10. This includes the functions of both the digital camera 30 and the pico-projector 50. In this embodiment, the UI 16 includes one or more user controls 18 and a display 20. Although not specifically seen here, the UI 16 may also comprise a microphone and a speaker. The user controls 18 may comprise a variety of knobs, switches, keys, button controls, or dials, for example, distributed across the housing of the digital camera device 10. Display 20 permits users to view the status of the digital camera 30 and/or the pico-projector 50, as well as view and select menu options. Display 20 acts as a viewfinder that permits the user to preview images and video that will be captured by digital camera 30, as well as to view the images and video after they are captured.

The digital camera 30 comprises a camera interface 32, a lens 34, a lens control 36, an image sensor 38, an image processor 40, and an optional flash 42. The camera interface 32 interfaces the components of digital camera 30 to the controller 12. In one embodiment, the camera interface 32 receives commands from the controller 12, such as user commands generated using the UI 16 and control signals used for timing synchronization. Lens 34, which may comprise one or more lenses (fixed or auto-focus), and which may comprise mechanical or electronic shutters, manipulates an image by collecting and focusing light onto the image sensor 38 based on control signals received from lens control 36. Lens control 36 controls the optical properties of lens 34, such as focus, zoom, exposure time, and shutter speed, based on control signals received from controller 12 and UI 16.

Image sensor 38 captures the images formed by lens 34, and may comprise any conventional image sensor, such as a charge-coupled device (CCD), a complementary metal oxide semiconductor (CMOS) image sensor, and the like. Generally, the image sensor 38 converts light focused by lens 34 into analog electrical signals for image processor 40. When CCD devices are used, additional digital-to-analog converters may be disposed between the CCD device and the image processor 40 to convert the digital signal provided by the CCD device to an analog signal usable by the image processor 40. Image processor 40 may process this raw image data for subsequent storage in memory 14, or for output to display 20, for example.

As stated above, the controller 12 may be configured to generate the control/timing signal that is used in the synchronization process. However, the present invention is not so limited. In another embodiment, the image processor 40 generates the control signal and provides it to either the lens control 36 or the pico-projector engine 52. As described in more detail below, one or both of the image processor 40 and the pico-projector engine 52 may be configured to perform the synchronization process to reduce or eliminate the Moiré patterns. So reduced, the image processor 40 can more accurately analyze the images being recorded to detect a hand gesture.

The pico-projector 50 comprises a miniaturized projection device integrated within the housing of the digital camera 10. The pico-projector 50 functions to project digital images and/or video that are retrieved from memory 14, for example, onto a nearby viewing surface, such as a wall or movie screen. As seen in FIG. 3, the pico-projector 50 comprises a projector engine 52, a laser light source 54, an optical combiner 56, one or more scanning mirrors 58, and a lens 60.

The projector engine 52 comprises the electronic circuitry required to convert received images and video data into a plurality of electronic signals, which are then used to drive the laser light source 54 to generate light. In one embodiment, the images received for projection produced using a complementary metal oxide semiconductor (CMOS) image sensor. CMOS image sensors derive intensity information using a plurality of photovoltaic cells, and filter the information through a color filter, for example, to derive color information. An image processor, such as image processor 40, then processes the color information and generates color values.

When the projector engine 52 receives an image for projection, the projector engine 52 may utilize any known technique to deconstruct the image into the plurality of electronic signals. For example, in one embodiment, the projector engine 52 analyzes this raw image data to derive the color and intensity information for each pixel in the image. The projector engine 52 then provides electronic signals representing the color and intensity information for the pixels to the laser light source 54.

The laser light source 54 comprises three miniature lasers. In this embodiment, there is one laser for each primary color—red, green, and blue. The electronic signals (i.e., the color and intensity information) received from the projector engine 52 are applied to each of the lasers in the laser light source 54. In response, each laser outputs a corresponding red light, green light, or blue light towards the optical combiner 56. The optical combiner 56 then combines the separate red, green, and blue lights into a single modulated light beam representing the derived color and intensity information for a particular pixel.

The modulated light beam is output to a scanning mirror 58, which in one embodiment, comprises a micro electro-mechanical system (MEMS) scanning mirror. As is known in the art, MEMS devices are very small mechanical devices that are driven by electricity. In the present invention, the scanning mirror 58 receives the light directed onto it by the optical combiner 56, and redirects the light beam towards the lens 60 to reproduce the image pixel by pixel on the external flat surface (e.g., the wall).

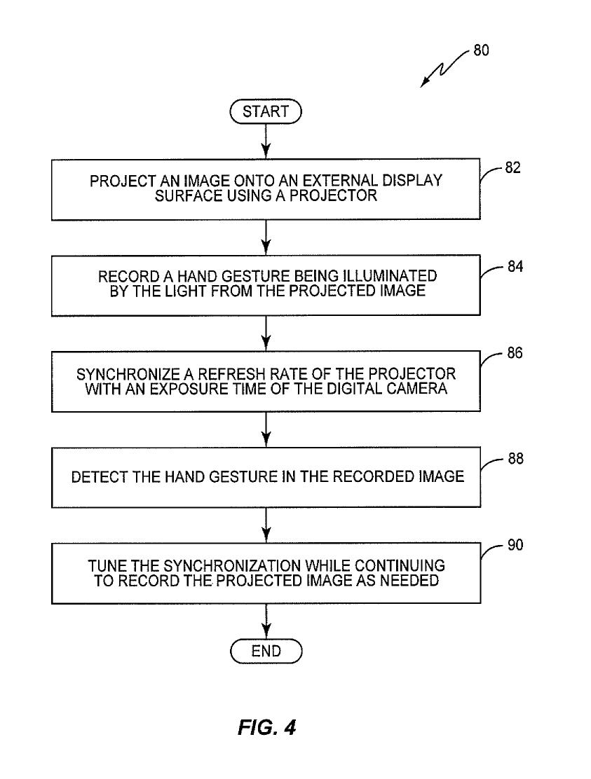

FIG. 4 illustrates a method 80 of performing one embodiment of the present invention. The method seen in FIG. 4 is described in the context of a single integrated device comprising both the digital camera assembly 30 and the projector assembly 50. However, those skilled in the art will appreciate that this is for illustrative purposes only.

The method 80 begins when the pico-projector 50 projects a video image 70 onto an external display surface (box 82). While the pico-projector 50 projects the video image 70, the digital camera 30 records the projected video image 70. Particularly, the digital camera 30 records a hand gesture that is being illuminated by the projected video image 70 (box 84). If the timing of the pico-projector 50 and the digital camera are out of sync, Moiré patterns or other interference patterns may become visible, and thus, recorded by the digital camera 30. As stated above, the presence of such patterns interferes with the ability of the digital camera 30 to detect the hand gestures. Therefore, while the digital camera 30 continues recording, the projector engine 52 synchronizes the refresh rate of the projector 50 to the exposure time of the digital camera 30 (box 86). This synchronization reduces or eliminates the timing factors that cause the undesirable Moiré patterns.

The generated control signal on which the synchronization is based can be any signal suitable for use as a timing signal. For example, in one embodiment, the control signal comprises a vertical synchronization signal (VSYNC) generated at controller 12. Conventionally, VSYNC signals are used to synchronize frame changes with a vertical blanking interval to ensure that a frame buffer begins filling with image data in sync with the VSYNC signal. This ensures that the entire frame buffer fills only with the data from a given image, and thus, only whole frames are projected onto an external surface when the buffer fills.

However, the present invention is concerned with reducing or eliminating the presence of Moiré patterns to detect hand gestures. Therefore, in one embodiment of the present invention, the synchronization process utilizes the VSYNC signal to perform this function. Particularly, the VSYNC signal may be generated based on the start of the exposure of the digital camera 30 and sent to the projector engine 52. Circuitry within the projector engine 52 then synchronizes the projector's refresh rate to the VSYNC signal. A refresh rate is the number of times per second that projector engine 52 outputs the image data to the laser light source 54. Thus, in one embodiment of the present invention, the projector engine 52 synchronizes outputting the image data from the frame buffer to the laser light source based on the VSYNC signal.

When the projector engine 52 outputs the contents of the frame buffer, the laser light source 54, the optical combiner 56, and the scanning mirror 58 function to project the image data onto the external display surface. The digital camera 30 then records hand gestures illuminated by the projected image 70 and processes the recorded image to detect the presence of the hand gesture (box 88). Because the refresh rate has been synchronized to the generated VSYNC signal, which is generated, for example, based on the start of the exposure of the digital camera assembly 30, the Moiré patterns are reduced or eliminated. Therefore, the image processor 40 can analyze the content of the recorded image to detect whether a hand gesture is being performed.

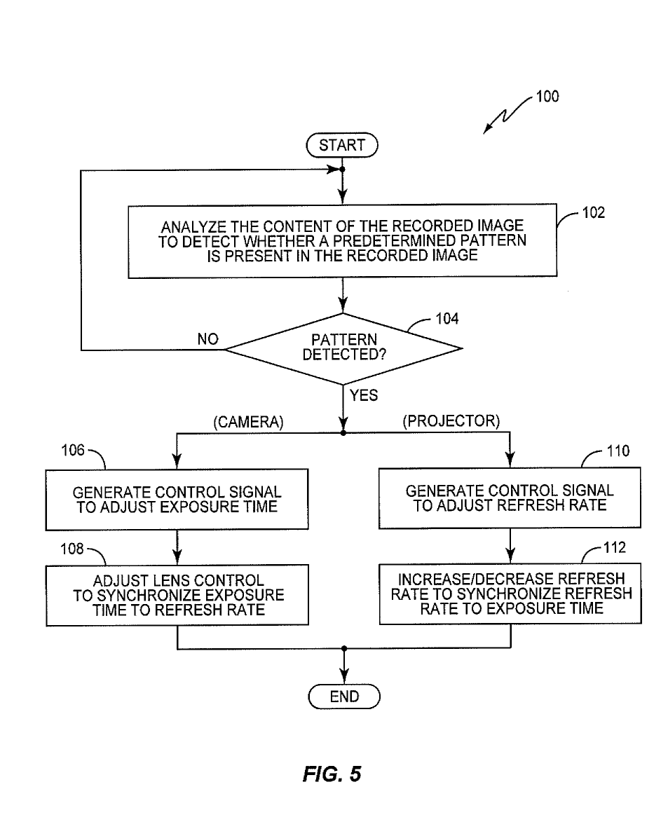

In some cases, the synchronization process may not be able to completely eliminate the Moiré patterns. Therefore, in one embodiment, the present invention allows the user to tune the synchronization while the digital camera 30 continues to record the projected image (box 90). Any method known in the art may be utilized to tune the synchronization. FIG. 5 illustrates one such method 100. Particularly, the image processor 40 comprises a pattern detection circuit and a reference timing circuit. The pattern detection circuit may be configured to utilize any well-known flicker detection algorithm to analyze the content of the captured images to detect periodic patterns (i.e., regions of change in multiple images of the same scene taken at different times) (box 102). If no pattern is detected (box 104), the pattern detection circuit simply continues to analyze the content of the captured images (box 102). However, when the pattern detection circuit does detect such a pattern (box 104), it may be configured to automatically adjust the synchronization in one or more ways. For example, either the digital camera 30 may synchronize its exposure time to the refresh rate of the pica-projector 50, or the pico-projector 50 may synchronize its refresh rate to the exposure time of the digital camera 30. In one embodiment, however, the image control processor 40 generates a signal indicating the detected pattern (box 106). This signal is then employed to control the lens control 36 to adjust the exposure time of the camera 10 (box 108).

In another embodiment, the pattern detection circuit cooperates with the reference timing circuit to automatically tune the synchronization. Particularly, the reference timing circuit generates the timing signal that may, as stated above, be used as the control signal at the projector engine 52. According to this embodiment of the present invention, the image processor 40 generates an adjustment control signal upon detecting a pattern (box 110). The reference timing circuit, based on this adjustment signal, then adjusts the periodicity with which the timing circuit generates the timing signal (i.e., increased or decreased) (box 112). The adjusted timing signal is then sent to the projector engine 52, as stated previously, thereby causing the projector engine 52 to increase or decrease the refresh rate of the projector engine 52.

The foregoing embodiments illustrate the imaging system 10 as comprising a unitary device that projects images captured and stored by digital camera 30. However, those skilled in the art should readily appreciate that the present invention is not so limited. For example, FIG. 6 is a perspective view illustrating another embodiment of the present invention in which the imaging system 10 has a communications interface 62. Via interface 62, the imaging system 10 may receive images and/or video from an external communications device 120, such as a SMARTPHONE or a Personal Digital Assistant (FDA), for example. Upon receiving the images, the pico-projector 50 projects the images onto a wall or other flat display surface. The imaging system 10 could be configured to generate a sync signal to control the refresh rate of the projector 50 as previously discussed.

As seen in FIG. 6, a cable 122 communicatively connects the imaging system 10 with the external device 120. However, this is for illustrative purposes only. In some embodiments, both the imaging system 10 and the communications device 120 are equipped with short-range transceivers, such as BLUETOOTH transceivers, to allow the bi-directional transfer of data and messages.

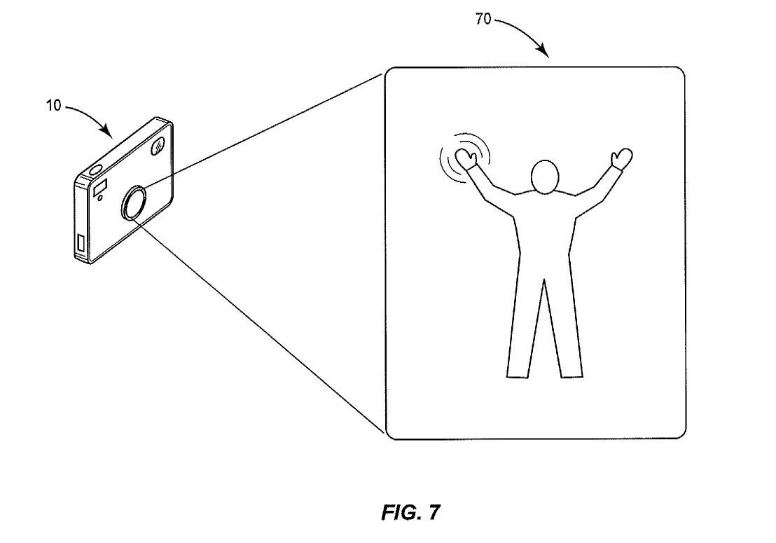

The present invention may, of course, be carried out in other ways than those specifically set forth herein without departing from essential characteristics of the invention. For example, the previous embodiments discuss the various embodiments of the present invention in which the hand gesture is illuminated by the projected image. However, in other embodiments, the digital camera 10 of the present invention may be configured to record and analyze the projected image 70 to detect the presence of a hand gesture being performed by a person in the projected image 70. FIG. 7 illustrates a person in a projected image 70 waving. The digital camera 30 records the image. According to the present invention, the digital camera 30 or the pico-projector 50 synchronizes the refresh rate of the projector with the exposure time of the digital camera 30.

Therefore, the present embodiments are to be considered in all respects as illustrative and not restrictive, and all changes coming within the meaning and equivalency range of the appended claims are intended to be embraced therein.

What is claimed is:

1. A method of detecting gestures in a recorded image, the method comprising:
projecting an image onto an external display surface using a projector;
recording a gesture in or illuminated by the projected image using a digital camera;
synchronizing a refresh rate of the projector with an exposure time of the digital camera; and
detecting the gesture in or illuminated by the recorded image.

2. The method of claim 1 further comprising analyzing the content of the recorded image to determine whether an interference pattern is visible in the recorded image.

3. The method of claim 2 wherein the interference pattern comprises a Moiré pattern.

4. The method of claim 2 wherein synchronizing a refresh rate of the projector with an exposure time of the digital camera comprises generating a control signal to filter the interference pattern from the image being recorded.

5. The method of claim 4 wherein generating the control signal comprises generating the control signal to synchronize the exposure time of a lens on the digital camera to the refresh rate of the projector.

6. The method of claim 4 wherein generating the control signal comprises generating a timing signal to synchronize the refresh rate of the projector to the exposure time of a lens on the digital camera.

7. The method of claim 4 further comprising tuning the synchronization of the projector to the digital camera while projecting the image onto the external display surface.

8. The method of claim 7 further comprising:
generating an adjusted control signal based on the generated control signal;
adjusting the synchronization of the refresh rate of the projector with the exposure time of the digital camera based on the adjusted control signal; and
projecting the image onto the external display surface according to the synchronized refresh rate.

9. The method of claim 1 further comprising image processing the recorded image to determine the gesture.

10. The method of claim 9 wherein the gesture is determined to be a hand gesture.

11. The method of claim 1 wherein synchronizing a refresh rate of the projector with an exposure time of the digital camera comprises synchronizing the refresh rate of the projector to a start of the exposure of the digital camera.

12. An imaging system for detecting gestures in a recorded image, the image-projection device comprising:
a projector configured to project an image onto an external display surface;
a digital camera to record a gesture in or illuminated by the projected image;
a controller connected to both the projector and the digital camera and configured to synchronize a refresh rate of the projector with an exposure time of the digital camera based on a generated control signal; and
an image processor configured to detect the gesture.

13. The system of claim 12 wherein the image processor is further configured to analyze the content of the recorded image to determine whether an interference pattern is present in the recorded image.

14. The system of claim 13 wherein the image processor is further configured to generate the control signal if the image processor detects the interference pattern.

15. The system of claim 14 wherein the controller is further configured to generate a timing signal responsive to receiving the control signal from the image processor.

16. The system of claim 14 wherein the projector is configured to generate a timing signal responsive to receiving the control signal.

17. The system of claim 12 wherein the controller is further configured to generate an adjusted timing signal to tune the synchronization of the refresh rate of the projector with a start of the exposure of the digital camera.

18. The system of claim 12 wherein the projector comprises a pico-projector and is integrated with the digital camera as a single device.
